(19) United States
(12) Patent Application Publication
(10) Pub. No.: US 2013/0114698 A1
(43) Pub. Date: May 9, 2013

(54) METHOD OF DETERMINING BINARY CODEWORDS FOR TRANSFORM COEFFICIENTS

(71) Applicant: General Instrument Corporation, Horsham, PA (US)

(72) Inventors: Jian Lou, San Diego, CA (US); Xue Fang, San Diego, CA (US); Limin Wang, San Diego, CA (US)

(73) Assignee: General Instrument Corporation, Horsham, PA (US)

(21) Appl. No.: 13/671,811

(22) Filed: Nov. 8, 2012

Related U.S. Application Data
(60) Provisional application No. 61/556,826, filed on Nov. 8, 2011.
(60) Provisional application No. 61/563,774, filed on Nov. 26, 2011.
(60) Provisional application No. 61/564,248, filed on Nov. 28, 2011.

(51) Int. Cl. H04N 7/26; H04N 7/30

(52) U.S. Cl. CPC H04N 19/00296; H04N 19/0009
USPC 375/240.03

(57) ABSTRACT

A system is provided for creating level parameter updating codewords for transform coefficients used for relating transform units (TUs) that divide up coding units (CUs) in a High Efficiency Video Coding (HEVC) system. The system provides binarization of the codewords and removes unnecessary operations to reduce system complexity and increase compression performance. The system generates transform coefficients that relate the TUs and begins by providing a parameter variable (cRiceParam) set to an initial value of zero. The parameter variable is then converted into a binary codeword based on the current value of the parameter variable and the value of a symbol and then updated with a new current value after each symbol has been converted. Updating can be provided with reference to table values or the values can be provided from combination logic.

### CROSS REFERENCE TO RELATED APPLICATIONS

This Application claims priority under 35 U.S.C. §119(e) from: earlier filed U.S. Provisional Application Ser. No. 61/556,826, filed Nov. 8, 2011; earlier filed U.S. Provisional Application Ser. No. 61/563,774, filed Nov. 26, 2011; and earlier filed U.S. Provisional Application Ser. No. 61/564,248, filed Nov. 28, 2011, the entirety of which are incorporated herein by reference.

### BACKGROUND

1. Technical Field

The present disclosure relates to the field of video compression, particularly video compression using High Efficiency Video Coding (HEVC) that employ block processing.

2. Related Art

FIG. 1 depicts a content distribution system 100 comprising a coding system 110 and a decoding system 140 that can be used to transmit and receive HEVC data. In some embodiments, the coding system 110 can comprise an input interface 130, a controller 111, a counter 112, a frame memory 113, an encoding unit 114, a transmitter buffer 115 and an output interface 135. The decoding system 140 can comprise a receiver buffer 150, a decoding unit 151, a frame memory 152 and a controller 153. The coding system 110 and the decoding system 140 can be coupled with each other via a transmission path which can carry a compressed bitstream 105. The controller 111 of the coding system 110 can control the amount of data to be transmitted on the basis of the capacity of the receiver buffer 150 and can include other parameters such as the amount of data per a unit of time. The controller 111 can control the encoding unit 114 to prevent the occurrence of a failure of a received signal decoding operation of the decoding system 140. The controller 111 can be a processor or include, by way of a non-limiting example, a microcomputer having a processor, a random access memory and a read only memory.

Source pictures 120 supplied from, by way of a non-limiting example, a content provider can include a video sequence of frames including source pictures in a video sequence. The source pictures 120 can be uncompressed or compressed. If the source pictures 120 are uncompressed, the coding system 110 can have an encoding function. If the source pictures 120 are compressed, the coding system 110 can have a transcoding function. Coding units can be derived from the source pictures utilizing the controller 111. The frame memory 113 can have a first area that can be used for storing the incoming frames from the source pictures 120 and a second area that can be used for reading out the frames and outputting them to the encoding unit 114. The controller 111 can output an area switching control signal 123 to the frame memory 113. The area switching control signal 123 can indicate whether the first area or the second area is to be utilized.

The controller 111 can output an encoding control signal 124 to the encoding unit 114. The encoding control signal 124 can cause the encoding unit 114 to start an encoding operation, such as preparing the Coding Units based on a source picture. In response to the encoding control signal 124 from the controller 111, the encoding unit 114 can begin to read out the prepared Coding Units to a high-efficiency encoding process, such as a prediction coding process or a transform coding process which process the prepared Coding Units generating video compression data based on the source pictures associated with the Coding Units.

The encoding unit 114 can package the generated video compression data in a packetized elementary stream (PES) including video packets. The encoding unit 114 can map the video packets into an encoded video signal 122 using control information and a program time stamp (PTS) and the encoded video signal 122 can be transmitted to the transmitter buffer 115.

The encoded video signal 122, including the generated video compression data, can be stored in the transmitter buffer 115. The information amount counter 112 can be incremented to indicate the total amount of data in the transmitter buffer 115. As data is retrieved and removed from the buffer, the counter 112 can be decremented to reflect the amount of data in the transmitter buffer 115. The occupied area information signal 126 can be transmitted to the counter 112 to indicate whether data from the encoding unit 114 has been added or removed from the transmitted buffer 115 so the counter 112 can be incremented or decremented. The controller 111 can control the production of video packets produced by the encoding unit 114 on the basis of the occupied area information 126 which can be communicated in order to anticipate, avoid, prevent, and/or detect an overflow or underflow from taking place in the transmitter buffer 115.

The information amount counter 112 can be reset in response to a preset signal 128 generated and output by the controller 111. After the information counter 112 is reset, it can count data output by the encoding unit 114 and obtain the amount of video compression data and/or video packets which have been generated. The information amount counter 112 can supply the controller 111 with an information amount signal 129 representative of the obtained amount of information. The controller 111 can control the encoding unit 114 so that there is no overflow at the transmitter buffer 115.

In some embodiments, the decoding system 140 can comprise an input interface 170, a receiver buffer 150, a controller 153, a frame memory 152, a decoding unit 151 and an output interface 175. The receiver buffer 150 of the decoding system 140 can temporarily store the compressed bitstream 105, including the received video compression data and video packets based on the source pictures from the source pictures 120. The decoding system 140 can read the control information and presentation time stamp information associated with video packets in the received data and output a frame number signal 163 which can be applied to the controller 153. The controller 153 can supervise the counted number of frames at a predetermined interval. By way of a non-limiting example, the controller 153 can supervise the counted number of frames each time the decoding unit 151 completes a decoding operation.

In some embodiments, when the frame number signal 163 indicates the receiver buffer 150 is at a predetermined capacity, the controller 153 can output a decoding start signal 164 to the decoding unit 151. When the frame number signal 163 indicates the receiver buffer 150 is at less than a predetermined capacity, the controller 153 can wait for the occurrence of a situation in which the counted number of frames becomes equal to the predetermined amount. The controller 153 can output the decoding start signal 164 when the situation occurs. By way of a non-limiting example, the controller 153 can output the decoding start signal 164 when the frame number signal 163 indicates the receiver buffer 150 is at the predetermined capacity. The encoded video packets and video compression data can be decoded in a monotonic order (i.e., increasing or decreasing) based on presentation time stamps associated with the encoded video packets.

In response to the decoding start signal 164, the decoding unit 151 can decode data amounting to one picture associated with a frame and compressed video data associated with the picture associated with video packets from the receiver buffer 150. The decoding unit 151 can write a decoded video signal 162 into the frame memory 152. The frame memory 152 can have a first area into which the decoded video signal is written, and a second area used for reading out decoded pictures 160 to the output interface 175.

In various embodiments, the coding system 110 can be incorporated or otherwise associated with a transcoder or an encoding apparatus at a headend and the decoding system 140 can be incorporated or otherwise associated with a downstream device, such as a mobile device, a set top box or a transcoder.

The coding system 110 and decoding system 140 can be utilized separately or together to encode and decode video data according to various coding formats, including High Efficiency Video Coding (HEVC). HEVC is a block based hybrid spatial and temporal predictive coding scheme. In HEVC, input images, such as video frames, can be divided into square blocks called Largest Coding Units (LCUs) 200, as shown in FIG. 2. LCUs 200 can each be as large as 128×128 pixels, unlike other coding schemes that break input images into macroblocks of 16×16 pixels. As shown in FIG. 3, each LCU 200 can be partitioned by splitting the LCU 200 into four Coding Units (CUs) 202. CUs 202 can be square blocks each a quarter size of the LCU 200. Each CU 202 can be further split into four smaller CUs 202 each a quarter size of the larger CU 202. By way of a non-limiting example, the CU 202 in the upper right corner of the LCU 200 depicted in FIG. 3 can be divided into four smaller CUs 202. In some embodiments, these smaller CUs 202 can be further split into even smaller sized quarters, and this process of splitting CUs 202 into smaller CUs 202 can be completed multiple times.

With higher and higher video data density, what is needed are further improved ways to code the CUs so that large input images and/or macroblocks can be rapidly, efficiently and accurately encoded and decoded.

### SUMMARY

The present invention provides an improved system for HEVC. In embodiments for the system, a method of determining binary codewords for transform coefficients in an efficient manner is provided. Codewords for the transform coefficients within transform units (TUs) that are subdivisions of the CUs 202 are used in encoding input images and/or macroblocks.

In one embodiment, a method is provided that comprises providing a transform unit including one or more subsets of transform coefficients, each transform coefficient having a quantized value, determining a symbol for each transform coefficient having a quantized value equal to or greater than a threshold value by subtracting the threshold value from the quantized value of the transform coefficient, providing a parameter variable set to an initial value of zero, converting each symbol into a binary codeword based on the current value of the parameter variable and the value of the symbol, and updating the value of the parameter variable with a new current value after each symbol has been converted, the new current value being based at least in part on the last value of the parameter variable and the value of the last converted symbol in the current or previous subset.

In another embodiment, the invention includes a method of determining binary codewords for transform coefficients that uses a look up table to determine the transform coefficients. The method comprises providing a transform unit comprising one or more subsets of transform coefficients, each transform coefficient having a quantized value, determining a symbol for each transform coefficient having a quantized value equal to or greater than a threshold value, by subtracting the threshold value from the quantized value of the transform coefficient, providing a parameter variable set to an initial value of zero, converting each symbol into a binary codeword based on the current value of the parameter variable and the value of the symbol, looking up a new current value from a table based on the last value of the parameter variable and the value of the last converted symbol, and replacing the value of the parameter variable with the new current value.

In another embodiment, the invention includes a method of determining binary codewords for transform coefficients that uses one or more mathematical conditions that can be performed using logic rather than requiring a look up table. The method comprises providing a transform unit comprising one or more subsets of transform coefficients, each transform coefficient having a quantized value, determining a symbol for each transform coefficient having a quantized value equal to or greater than a threshold value, by subtracting the threshold value from the quantized value of the transform coefficient, providing a parameter variable set to an initial value of zero, converting each symbol into a binary codeword based on the current value of the parameter variable and the value of the symbol, determining whether the last value of the parameter variable and the value of the last converted symbol together satisfy one or more conditions, and mathematically adding an integer of one to the last value of the parameter variable for each of the one or more conditions that is satisfied.

### BRIEF DESCRIPTION OF THE DRAWINGS

Further details of the present invention are explained with the help of the attached drawings in which:

FIG. 1 depicts an embodiment of a content distribution system.

FIG. 2 depicts an embodiment of an input image divided into Large Coding Units.

FIG. 3 depicts an embodiment of a Large Coding Unit divided into Coding Units.

FIG. 4 depicts a quadtree representation of a Large Coding Unit divided into Coding Units.

FIG. 5 depicts possible exemplary arrangements of Prediction Units within a Coding Unit.

FIG. 6 depicts a block diagram of an embodiment of a method for encoding and/or decoding a Prediction Unit.

FIG. 7 depicts an exemplary embodiment of a Coding Unit divided into Prediction Units and Transform Units.

FIG. 8 depicts an exemplary embodiment of a quadtree representation of a Coding Unit divided into Transform Units.

FIG. 9 depicts an embodiment of a method of performing context-based adaptive binary arithmetic coding.

FIG. 10 depicts an exemplary embodiment of a significance map.

FIG. 11 depicts an embodiment of a reverse zig-zag scan of transform coefficients within a Transform Unit and subsets of transform coefficients.

FIG. 12 depicts an embodiment of a method of obtaining coefficient levels and symbols for transform coefficients.

FIG. 13 depicts an embodiment of the scanning order of transform coefficients within subsets.

FIG. 14 depicts exemplary embodiments of maximum symbol values for associated parameter variables.

FIG. 15 depicts an exemplary embodiment of a table for converting symbols into binary codewords based on parameter variables.

FIG. 16 depicts an embodiment of a method for coding symbols and updating parameter variables.

FIG. 17 depicts an exemplary embodiment of a low complexity updating table with conditional symbol thresholds of 2, 4, 13, 11, and 10.

FIG. 18 depicts an exemplary embodiment of a low complexity updating table with conditional symbol thresholds of 3, 6, and 12.

FIG. 19 depicts an exemplary embodiment of a low complexity updating table with conditional symbol thresholds of 2, 5, and 11.

FIG. 20 depicts an exemplary embodiment of a combination logic representation of conditions for conditional symbol thresholds of 2, 4, 13, 11, and 10.

FIG. 21 depicts an exemplary embodiment of a combination logic representation of conditions for conditional symbol thresholds of 3, 6, and 12.

FIG. 22 depicts exemplary code that can be used to update the parameter variable based on conditional symbol thresholds of 2, 5, and 11.

FIG. 23 depicts an exemplary embodiment of a low complexity updating table with conditional symbol thresholds of A, B, and C.

FIG. 24 depicts an exemplary embodiment of a combination logic representation of conditions for conditional symbol thresholds of A, B, and C.

FIG. 25 depicts an exemplary embodiment of a low complexity updating table with conditional symbol thresholds of 2, 4, and 12.

FIG. 26 depicts an exemplary embodiment of a combination logic representation of conditions for conditional symbol thresholds of 2, 4, and 12.

FIG. 27 depicts an exemplary embodiment of a low complexity updating table with conditional symbol thresholds of 2, 4, and 13.

FIG. 28 depicts an exemplary embodiment of a combination logic representation of conditions for conditional symbol thresholds of 2, 4, and 13.

FIG. 29 depicts an exemplary embodiment of a low complexity updating table with conditional symbol thresholds of 2, 4, and 11.

FIG. 30 depicts an exemplary embodiment of a combination logic representation of conditions for conditional symbol thresholds of 2, 4, and 11.

FIG. 31 depicts an exemplary embodiment of a low complexity updating table with conditional symbol thresholds of 2, 4, and 10.

FIG. 32 depicts an exemplary embodiment of a combination logic representation of conditions for conditional symbol thresholds of 2, 4, and 10.

FIG. 33 depicts an exemplary embodiment of computer hardware.

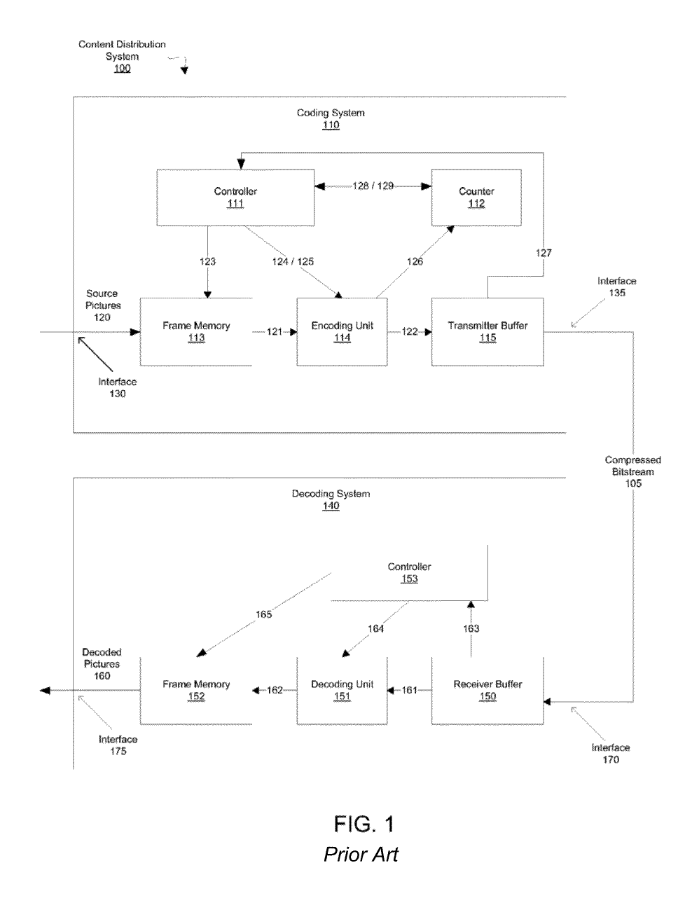

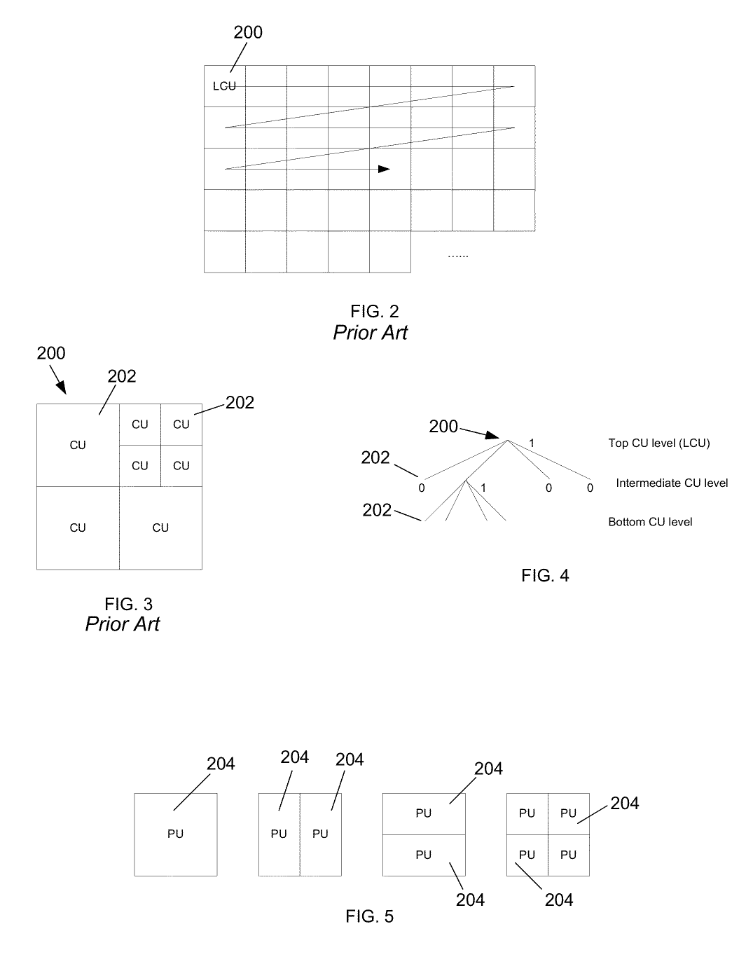

### DETAILED DESCRIPTION

In HEVC, an input image, such as a video frame, is broken up into CUs that are then identified in code. The CUs are then further broken into sub-units that are coded as will be described subsequently.

Initially for the coding a quadtree data representation can be used to describe the partition of a LCU 200. The quadtree representation can have nodes corresponding to the LCU 200 and CUs 202. At each node of the quadtree representation, a flag “1” can be assigned if the LCU 200 or CU 202 is split into four CUs 202. If the node is not split into CUs 202, a flag “0” can be assigned. By way of a non-limiting example, the quadtree representation shown in FIG. 4 can describe the LCU partition shown in FIG. 3, in which the LCU 200 is split into four CUs 202, and the second CU 202 is split into four smaller CUs 202. The binary data representation of the quadtree can be a CU split flag that can be coded and transmitted as overhead, along with other data such as a skip mode flag, merge mode flag, and the PU coding mode described subsequently. By way of a non-limiting example, the CU split flag quadtree representation shown in FIG. 4 can be coded as the binary data representation “10100.”

At each leaf of the quadtree, the final CUs 202 can be broken up into one or more blocks called prediction units (PUs) 204. PUs 204 can be square or rectangular. A CU 202 with dimensions of 2N×2N can have one of the four exemplary arrangements of PUs 204 shown in FIG. 5, with PUs 204 having dimensions of 2N×2N, 2N×N, N×2N, or N×N.

A PU can be obtained through spatial or temporal prediction. Temporal prediction is related to inter mode pictures. Spatial prediction relates to intra mode pictures. The PUs 204 of each CU 202 can, thus, be coded in either intra mode or inter mode. Features of coding relating to intra mode and inter mode pictures is described in the paragraphs to follow.

Intra mode coding can use data from the current input image, without referring to other images, to code an I picture. In intra mode the PUs 204 can be spatially predictive coded. Each PU 204 of a CU 202 can have its own spatial prediction direction. Spatial prediction directions can be horizontal, vertical, 45-degree diagonal, 135 degree diagonal, DC, planar, or any other direction. The spatial prediction direction for the PU 204 can be coded as a syntax element. In some embodiments, brightness information (Luma) and color information (Chroma) for the PU 204 can be predicted separately. In some embodiments, the number of Luma intra prediction modes for 4×4, 8×8, 16×16, 32×32, and 64×64 blocks can be 18, 35, 35, 35, and 4 respectively. In alternate embodiments, the number of Luma intra prediction modes for blocks of any size can be 35. An additional mode can used for the Chroma intra prediction mode. In some embodiments, the Chroma prediction mode can be called “IntraFromLuma.”

Inter mode coding can use data from the current input image and one or more reference images to code “P” pictures and/or “B” pictures. In some situations and/or embodiments, inter mode coding can result in higher compression than intra mode coding. In inter mode PUs 204 can be temporally predictive coded, such that each PU 204 of the CU 202 can have one or more motion vectors and one or more associated reference images. Temporal prediction can be performed through a motion estimation operation that searches for a best match prediction for the PU 204 over the associated reference images. The best match prediction can be described by the motion vectors and associated reference images. P pictures use data from the current input image and one or more previous reference images. B pictures use data from the current input image and both previous and subsequent reference images, and can have up to two motion vectors. The motion vectors and reference pictures can be coded in the HEVC bitstream. In some embodiments, the motion vectors can be coded as syntax elements “MV,” and the reference pictures can be coded as syntax elements “refIdx.” In some embodiments, inter mode coding can allow both spatial and temporal predictive coding.

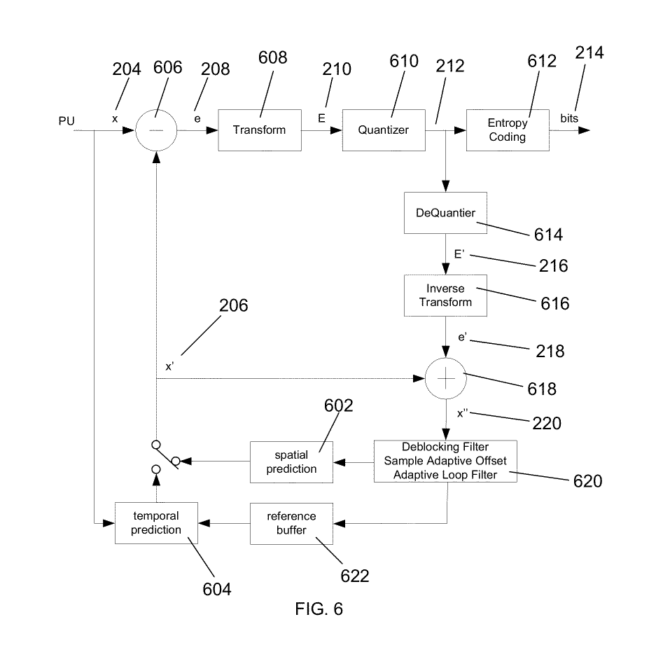

FIG. 6 depicts a block diagram of how a PU 204, x, can be encoded and/or decoded. At 606 a predicted PU 206, x′, that is predicted by intra mode at 602 or inter mode at 604, as described above, can be subtracted from the current PU 204, x, to obtain a residual PU 208, e. At 608 the residual PU 208, e, can be transformed with a block transform into one or more transform units (TUs) 210, E. Each TU 210 can comprise one or more transform coefficients 212. In some embodiments, the block transform can be square. In alternate embodiments, the block transform can be non-square.

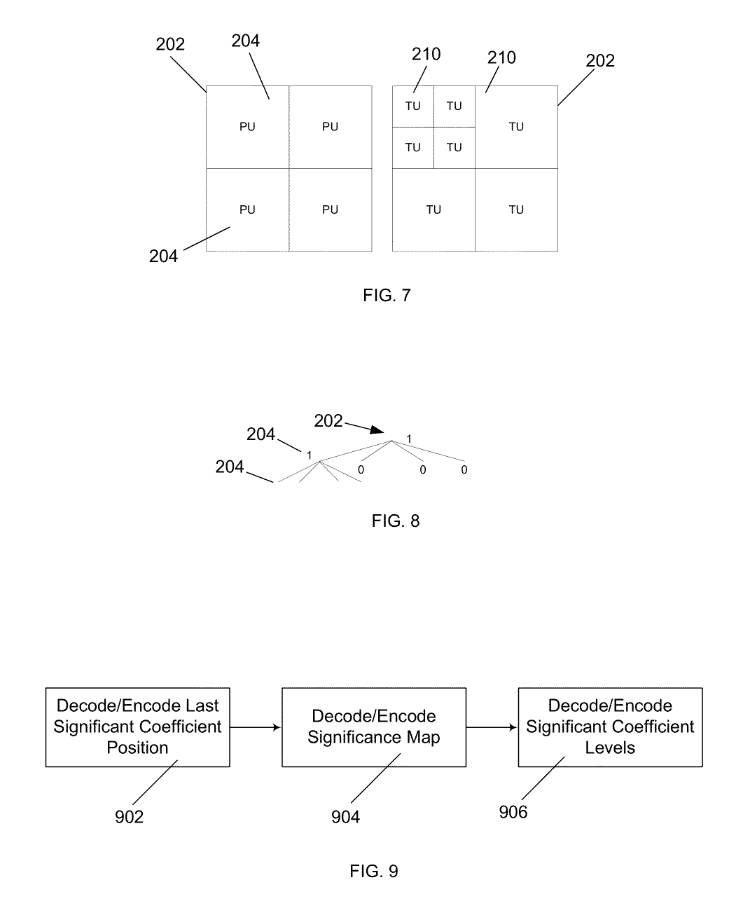

As shown in FIG. 7, in HEVC, a set of block transforms of different sizes can be performed on a CU 202, such that some PUs 204 can be divided into smaller TUs 210 and other PUs 204 can have TUs 210 the same size as the PU 204. Division of CUs 202 and PUs 204 into TUs 210 can be shown by a quadtree representation. By way of a non-limiting example, the quadtree representation shown in FIG. 8 depicts the arrangement of TUs 210 within the CU 202 shown in FIG. 7.

Referring back to FIG. 6, at 610 the transform coefficients 212 of the TU 210, E, can be quantized into one of a finite number of possible values. In some embodiments, this is a lossy operation in which data lost by quantization may not be recoverable. After the transform coefficients 212 have been quantized, at 612 the quantized transform coefficients 212 can be entropy coded, as discussed below, to obtain the final compression bits 214.

At 614 the quantized transform coefficients 212 can be dequantized into dequantized transform coefficients 216 E′. At 616 the dequantized transform coefficients 216 E′ can then be inverse transformed to reconstruct the residual PU 218, e′. At 618 the reconstructed residual PU 218, e′, can then be added to a corresponding prediction PU 206, x′, obtained through either spatial prediction at 602 or temporal prediction at 604, to obtain a reconstructed PU 220, x″. At 620 a deblocking filter can be used on reconstructed PUs 220, x″, to reduce blocking artifacts. At 620 a sample adaptive offset process is also provided that can be conditionally performed to compensate the pixel value offset between reconstructed pixels and original pixels. Further, at 620, an adaptive loop filter can be conditionally used on the reconstructed PUs 220, x″, to reduce or minimize coding distortion between input and output images.

If the reconstructed image is a reference image that will be used for future temporal prediction in inter mode coding, the reconstructed images can be stored in a reference buffer 622. Intra mode coded images can be a possible point where decoding can begin without needing additional reconstructed images.

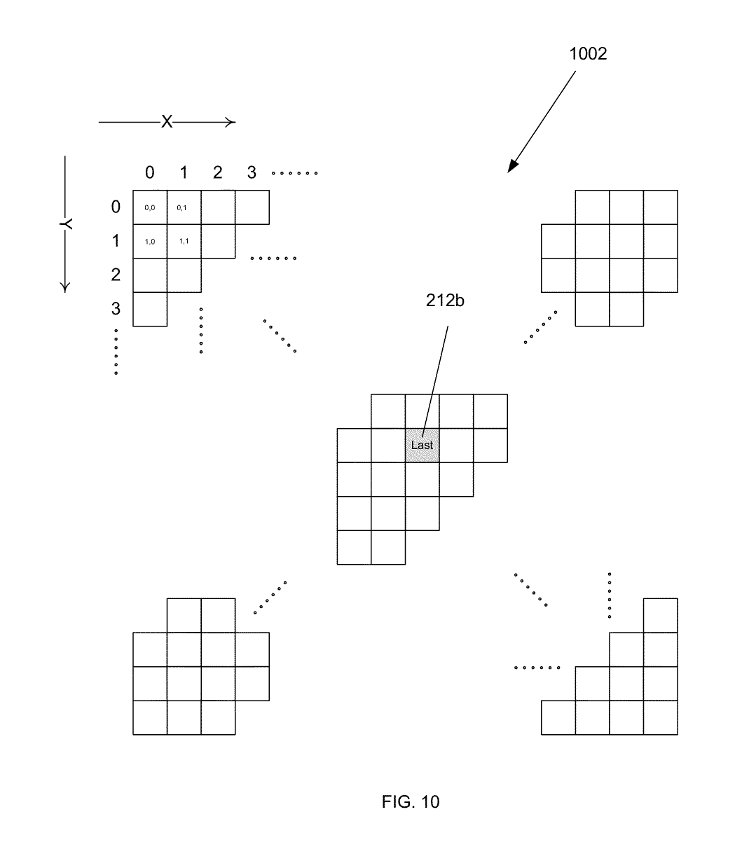

HEVC can use entropy coding schemes during step 612 such as context-based adaptive binary arithmetic coding (CABAC). The coding process for CABAC is shown in FIG. 9. At 902, the position of the last significant transform coefficient of the transform units 210 can be coded. Referring back to FIG. 6, the quantized transform coefficients are created by quantizing the TUs 210. Transform coefficients 212 can be significant or insignificant. FIG. 10 shows a significance map 1002 of the transform coefficients 212. Insignificant transform coefficients 212 can have a quantized value of zero, while significant transform coefficients 212 can have a quantized value of one or more. In some embodiments, significant transform coefficients 212 can also be known as non-zero quantized transform coefficients 212. If a TU 210 comprises one or more significant transform coefficients 212, the coordinates of the last significant transform coefficient 212 along a forward zig-zag coding scan from the top left corner of the TU 210 to the lower right corner of the TU 210, as shown in FIG. 10, can be coded. In alternate embodiments, the significant transform coefficients 212 can be scanned along an inverse wavefront scan, inverse horizontal scan, inverse vertical scan, or any other scan order. In some embodiments, these coordinates can be coded as the syntax elements “last_significant_coeff_y” and “last_significant_coeff_x.” By way of a non-limiting example, FIG. 10 depicts the position of the last significant transform 212b within a TU 210 which is being coded in block 902 of FIG. 9.

At block 904 in FIG. 9, the significance map 1002 can be coded to indicate the positions of each of the significant transform coefficients 212 in the TU 210. A significance map 1002 can comprise a binary element for each position in the TU 210. The binary element can be coded as “0” to indicate that the transform coefficient 212 at that position is not significant. The binary element can be coded as “1” to indicate that the transform coefficient 212 at that position is significant.

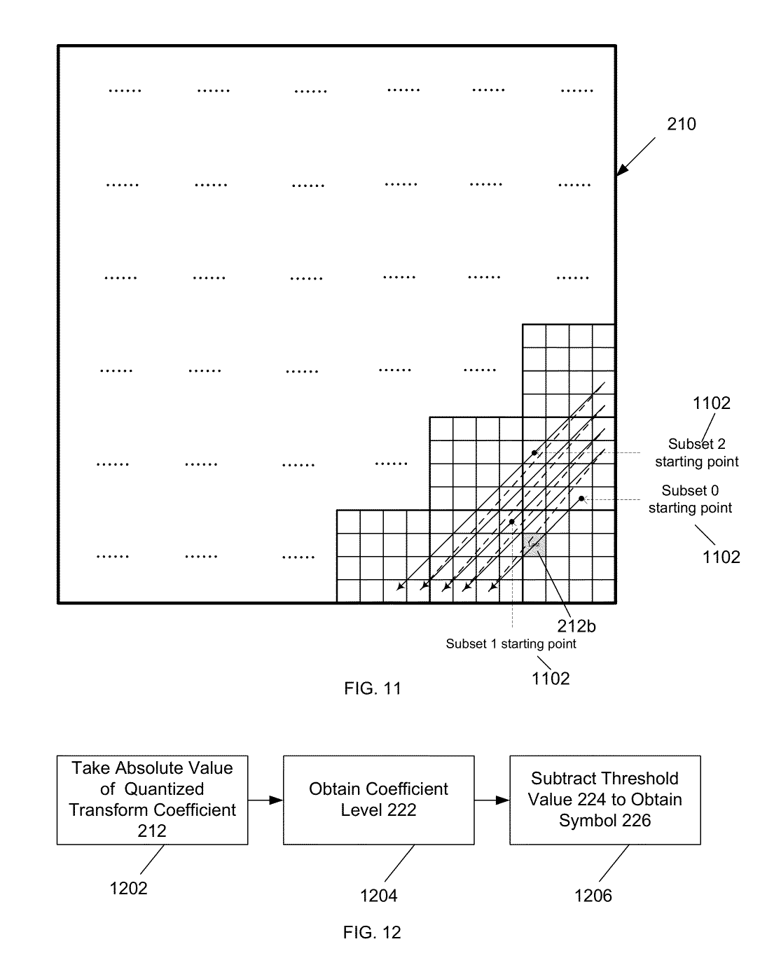

FIG. 11 illustrates how the quantized transform coefficients 212 of the TUs 210 can be divided into groups. In some embodiments, the groups can be sub-blocks. Sub-blocks can be square blocks of 16 quantized transform coefficients 212. In other embodiments, the groups can be subsets 1102. Subsets 1102 can comprise 16 quantized transform coefficients 212 that are consecutive along the scan order of a backwards zig-zag scan, as shown in FIG. 11. The first subset can be the subset 1102 that includes the last significant transform coefficient 212b, regardless of where the last significant transform coefficient 212b is within the subset. By way of a non-limiting example, the last significant transform coefficient 212b can be the 14th transform coefficient 212 in the subset, followed by two insignificant transform coefficients.

In some situations and/or embodiments, there can be one or more groups of 16 quantized transform coefficients 212 that do not contain a significant transform coefficient along the reverse scan order prior to the group containing the last significant transform coefficient 212b. In these situations and/or embodiments, the first subset can be the subset 1102 containing the last significant transform coefficient 212b, and any groups before the first subset 1102 are not considered part of a subset 1102. By way of a non-limiting example, in FIG. 11, the first subset 1102 “Subset 0” is the second grouping of 16 transform coefficients 212 along the reverse zig-zap scan order, while the group of 16 transform coefficients 212 at the lower right corner of the TU 210 are not part of a subset 1102 because none of those transform coefficients 212 are significant. In some embodiments, the first subset 1102 can be denoted as “subset 0,” and additional subsets 1102 can be denoted as “subset 1,” “subset 2,” up to “subset N.” The last subset 1102 can be the subset 1102 with the DC transform coefficient 212 at position 0, 0 at the upper left corner of the TU 210.

Referring back to FIG. 9 in the last block 906, each quantized transform coefficient 212 can be coded into binary values to obtain final compression bits 214 shown in FIG. 6, including coding for significant coefficient levels. During coding the absolute value of each quantized transform coefficient 212 can be coded separately from the sign of the quantized transform coefficient 212. FIG. 12 illustrates coding steps that deal with taking an absolute value of the quantized transform coefficients. As shown in FIG. 12, at 1202 the absolute value of each quantized transform coefficient 212 can be taken to enable obtaining the coefficient level 222 for that quantized transform coefficient 212 at block 1204.

The coefficient levels 222 obtained at block 1204 that are expected to occur with a higher frequency can be coded before coefficient levels 222 that are expected to occur with lower frequencies. By way of a non-limiting example, in some embodiments coefficient levels 222 of 0, 1, or 2 can be expected to occur most frequently. Coding the coefficient levels 222 in three parts can identify the most frequently occurring coefficient levels 222, leaving more complex calculations for the coefficient levels 222 that can be expected to occur less frequently. In some embodiments, this can be done by coding the coefficient levels 222 in three parts. First, the coefficient level 222 of a quantized transform coefficient 212 can be checked to determine whether it is greater than one. If the coefficient level 222 is greater than one, the coefficient level 222 can be checked to determine whether it is greater than two.

At 1206 in FIG. 12, if the coefficient level 222 is greater than two, the coefficient level 222 can be subtracted by a threshold value 224 of three to obtain a symbol. By way of a non-limiting example, in some embodiments, the coefficient level 222 can be coded as three variables: “coeff_abs_level_greater1_flag,” “coeff_abs_level_greater2_flag,” and “coeff_abs_level_minus3.” For quantized transform coefficients 212 with a coefficient level 222 of two or more, “coeff_abs_level_greater1_flag” can be set to “1.” If “coeff_abs_level_greater1_flag” is set to “1” and the quantized transform coefficient 212 also has a coefficient level 222 of three or more, “coeff_abs_level_greater2_flag” can be set to “1.” If “coeff_abs_level_greater2_flag” is set to “1,” the threshold value 224 of three can be subtracted from the coefficient level 222 to get the quantized transform coefficient's symbol 226, coded as “coeff_abs_level_minus3.” In alternate embodiments, the coefficient level 222 can be coded in a different number of parts, and/or the threshold value 224 can be an integer other than three.

For the quantized transform coefficients 212 that occur less frequently and have coefficient levels 222 of three or more as determined in the blocks of FIG. 12, as determined in the blocks of FIG. 12, the quantized transform coefficient's symbol 226 can be converted to a binary codeword 228 that can be part of the final compression bits 214 generated as shown in FIG. 6.

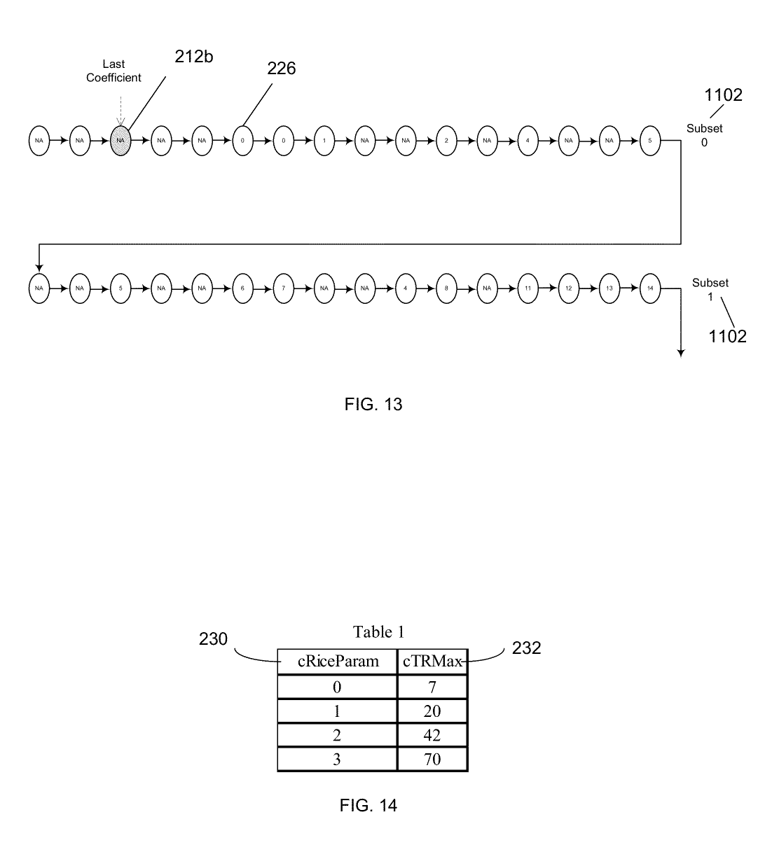

FIG. 13 illustrates how each symbol 226 can be coded by scanning through each subset 1102 and converting each symbol 226 of the subset 1102 in order according to the value of the parameter variable 230, and then moving to the symbols 226 of the next subset 1102. The conversion to a binary codeword 228 can be performed with Truncated Rice code alone, or with a combination of Truncated Rice code and 0th order exponential-Golomb (Exp-Golomb) code. The Truncated Rice code can obtain a binary codeword 228 based a parameter variable 230 and the symbol 226. A diagram showing this coding progression is shown in FIG. 13 for the subsets 0 and 1 along the zig-zag lines of FIG. 11. In some embodiments, the current scanning position can be denoted by “n.”

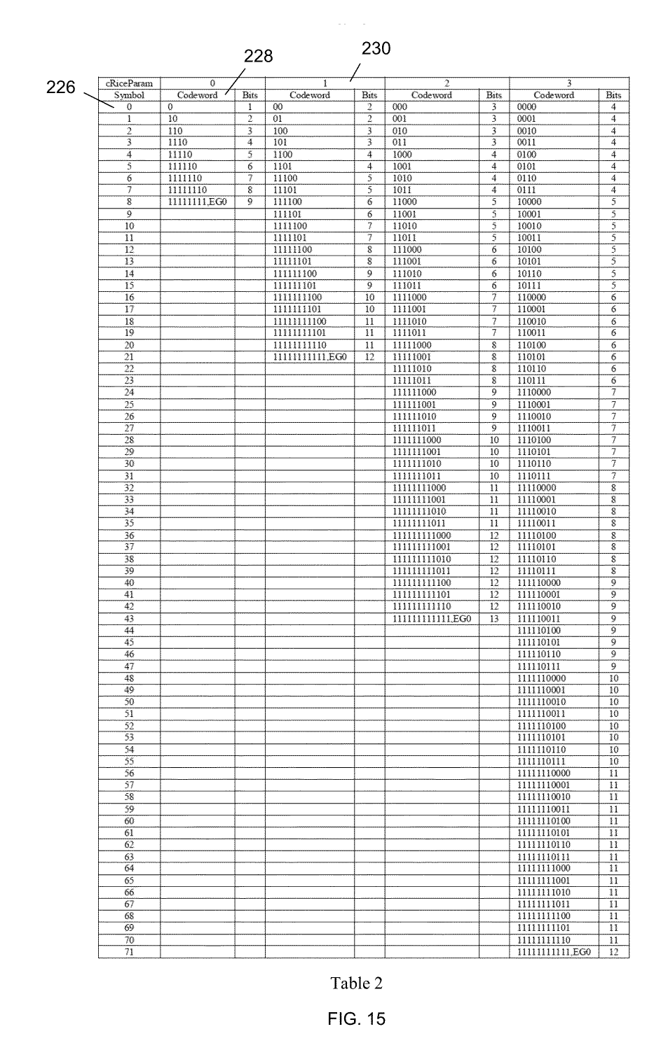

Referring to FIG. 15, the parameter variable 230 can be a global variable that can be updated as each symbol 226 is coded. The parameter variable 230 can control the flatness of the codeword distribution. In some embodiments, the parameter variable 230 can be any integer between 0 and N. By way of a non-limiting example, in some embodiments N can be 3, such that the parameter variable 230 can be 0, 1, 2, or 3. In some embodiments, the parameter variable 230 can be denoted as “cRiceParam” as illustrated in FIG. 15 as well as FIG. 14.

Referring still to FIG. 14, each parameter variable 230 can have an associated maximum symbol value 232 that denotes the truncation point for the Truncated Rice code. In some embodiments, the maximum symbol value 232 for a particular parameter variable 230 can be denoted as “cTRMax” 232 as illustrated in FIG. 14 which depicts an exemplary table of maximum symbol values 232 “cTRMax” for parameter variables 230 “cRiceParam.” The table of FIG. 14 is labeled as Table 1, as it provides a first listing cRiceParam values 230 relative to maximum value symbols cTRMax 232. If the symbol 226 of FIG. 15 is less than or equal to the maximum symbol value 232 for the parameter variable 230, the symbol 226 can be converted into a binary codeword 228 using only Truncated Rice code. If the symbol 226 is greater than the maximum symbol value 232 for the parameter variable 230, the binary codeword 228 can be generated using a combination of the Truncated Rice code and Exp-Golomb code, with the Truncated Rice codeword for the maximum symbol value 232 being concatenated with the 0th order Exp-Golomb code for the symbol 226 minus the maximum symbol value 232 minus one. By way of a non-limiting example, FIG. 15 depicts an exemplary table of binary codewords 228 generated based on symbols 226 and parameter variables 230. Since FIG. 15 provides a second table listing cRiceParam parameter variables 230 relative to other values, it is labeled as Table 2.

In some situations and/or embodiments, converting the symbol 226 according to Truncated Rice code with a lower parameter variable 230 can result in a binary codeword 228 having fewer bits than converting the same symbol 226 according to Truncated Rice code with a higher parameter variable 230. By way of a non-limiting example, as shown by the table depicted in FIG. 15, using a parameter variable 230 of 0 to convert a symbol 226 of 0 can result in the binary codeword 228 of “0” having 1 bit, while using the parameter variable 230 of 1 to convert the symbol 226 of 0 can result in the binary codeword 228 of “00” having 2 bits.

In other situations and/or embodiments, converting the symbol 226 according to Truncated Rice code with a higher parameter variable 230 can result in a binary codeword 228 having fewer bits than converting the same symbol 226 according to Truncated Rice code with a lower parameter variable 230. By way of a non-limiting example, as shown in the table depicted in FIG. 14, using a parameter variable 230 of 0 to convert a symbol 226 of 6 can result in the binary codeword 228 of “1111110” having 7 bits, while using the parameter variable 230 of 2 to convert the symbol 226 of 6 can result in the binary codeword 228 of “1010” having 4 bits.

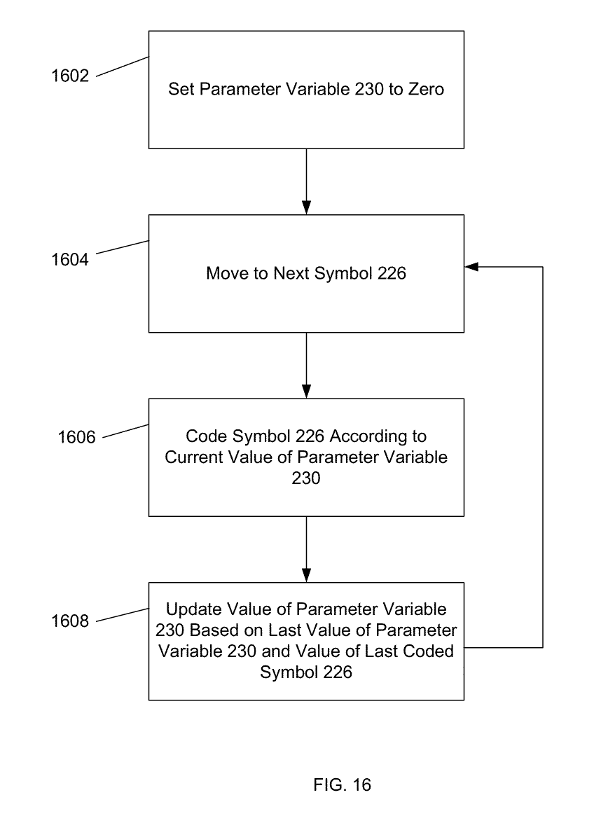

FIG. 16 is a flow chart depicting a method for entropy coding the symbols 226. At 1602, for each TU 210, the parameter variable 230 can be initially set to a value of zero. At 1604 the coding system 110 can move to the next symbol 226. In some situations and/or embodiments, the next symbol 226 can be the first symbol 226 in the first subset 1102 as illustrated in FIG. 11. At 1606, the symbol 226 can be coded with Truncated Rice and/or Exp-Golomb code using the current value of the parameter variable 230. At 1608, the parameter variable 230 can be updated based on the last value of the parameter variable 230 and the value of the last symbol 226 that was coded. In some situations and/or embodiments, the updated value of the parameter variable 230 can be the same as the last value of the parameter variable 230. In other situations and/or embodiments, the updated value of the parameter variable 230 can be greater than the last value of the parameter variable 230. The parameter variable 230 can be updated based upon calculations or upon values derived from a table as described herein subsequently.

After the parameter variable 230 has been updated at 1608, the coding system 110 can return to 1604 and move to the next symbol 226. The next symbol 226 can be in the current subset 1102 or in the next subset 1102. The next symbol 226 can then be coded at 1606 using the updated value of the parameter variable 230 and the process can repeat for all remaining symbols 226 in the TU 210. In some embodiments, when symbols 226 in a subsequent subset 1102 are coded, the parameter variable 230 can be updated based on the last value of the parameter variable 230 from the previous subset 1102, such that the parameter variable 230 is not reset to zero at the first symbol 226 of each subset 1102. In alternate embodiments, the parameter variable 230 can be set to zero at the first symbol 226 of each subset 1102.

Generally referring to FIG. 15, Truncated Rice code with a smaller cRiceParam parameter value 230 can be preferred to code the symbols with smaller codewords, as they need fewer bits to represent. For example, if a symbol 226 has a value of 0, using Truncated Rice code with a cRiceParam parameter value 230 equal to 0, only 1 bit is needed, but 2, 3, or 4 bits are needed when the cRiceParam value is 2, 3, or 4, respectively. If a symbol has a value of 6, using Truncated Rice code with a cRiceParam value equal to 0, 7 bits are needed. But 5, 4, or 4 bits are needed when the cRiceParam value is 2, 3, or 4, respectively.

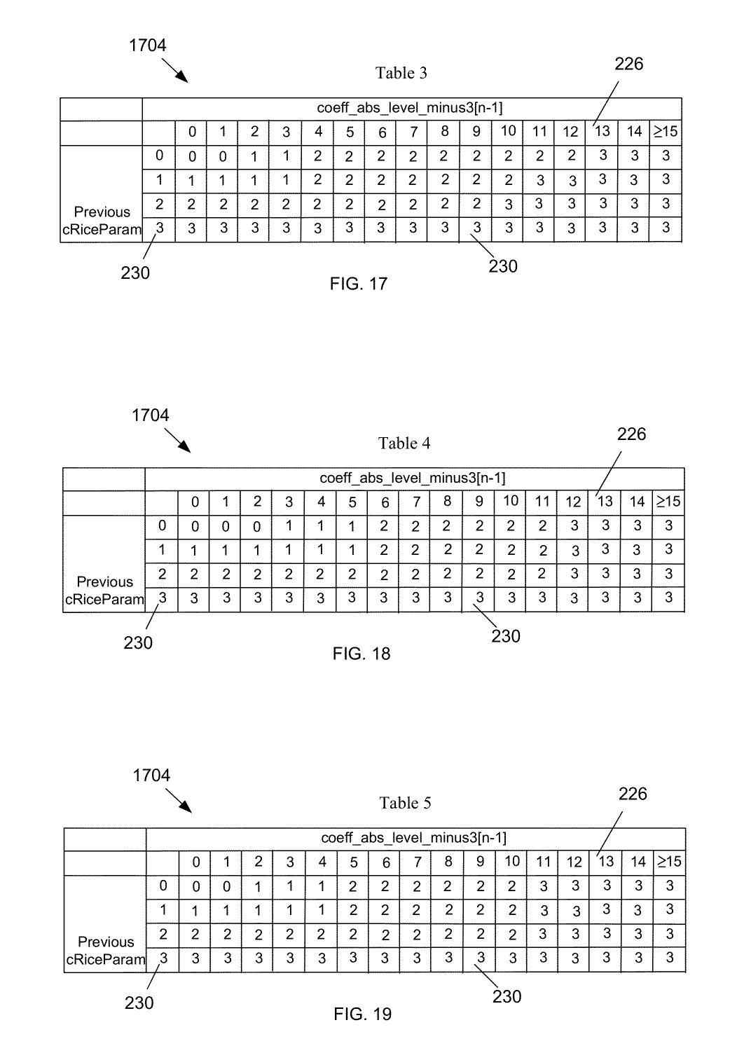

In one embodiment illustrated with the table of FIG. 17, the cRiceParam 230 labeled with a variable coeff_level_minus3[n] is derived and updated based on a table as follows. For a TU subset, the cRiceParam 230 is initially set to 0, and is then updated based on the previous cRiceParam and the coeff_abs_level_minus3[n−1] according to the table of FIG. 17. Because FIG. 17 shows a third table listing symbol values 226 relative to cRiceParam parameter values 230, the table is labeled as Table 3. Subsequent tables showing a similar comparison will, likewise, be labeled consecutively.

Note that in conventional implementations, cRiceParam 230 is reset once per subset with initial “0” values. For a TU with more than one subset of 16 consecutive symbol coefficients 226, the cRiceParam calculation for coeff_abs_level_minus3 can be reset to 0 for each subset, which favors smaller symbol value coding. Generally, inside each TU, starting from the last non-zero quantized transform coefficient, the absolute values of the non-zero quantized transform coefficients tend to get larger and larger. Therefore, resetting cRiceParam to 0 for each subset might not give optimal compression performance.

In FIG. 13, each circle stands for a quantized transform coefficient and the number inside each circle is the value of coeff_abs_level_minus3. If it is “NA”, it means there is no syntax of coeff_abs_level_minus3 for that coefficient. Following the reverse scanning pattern, the values of coeff_abs_level_minus3 tend to get larger within each subset and also from subset to subset, as shown in the example of FIG. 13. In the example, cRiceParam is set to 2 for “5” in subset 0, and with cRiceParam set to 2, the value of “5” is binarized into a codeword of “1001”, or 4 bits, as shown in Table 2 of FIG. 15. In conventional implementations, cRiceParam is then reset to 0 in subset 1. Now, with the reset cRiceParam of 0, the same value of “5” in subset 1 is now binarized into a codeword of 111110, or 6 bits, as shown in Table 2. Clearly, this resetting process not only introduces additional checking operations, but also can possibly result in inferior coding performance.

Tables 4 and 5 as illustrated in respective FIGS. 18 and 19 depict alternate embodiments on an update table. For these and other embodiments, the cRiceParam parameters 230 are derived as follows. First, for a TU, cRiceParam is initially set to 0, and is then updated based on the previous cRiceParam and coeff_abs_level_minus3[n−1] according to a cRiceParam update table, such as Tables 4 and 5. In these embodiments, cRiceParam is only reset once per TU, and not per subset of a TU as indicated with respect to the embodiment using Table 3.

By not resetting the cRiceParam to 0 at each subset, the operations of resetting for each subset are saved and once the cRiceParam reaches 3, the symbols will always be binarized with the same set truncated rice codes (cRiceParam equals 3), which can reduce hardware complexity.

Note that Table 5 of FIG. 19 is generated from Table 2 of FIG. 15 by analyzing the number of bits needed for each symbol 226 with a different cRiceParam value 230 while assuming the next level value is statistically no smaller than the current level along a reverse scan. For example, if the current symbol 226 is 2 and the cRiceParam is 0, the chance that the next symbol is larger than 2 is high and applying Truncated Rice code with cRiceParam equal to 1 might reduce the number of bits. If the current symbol is 5 and cRiceParam is 1, the chance that the next symbol is larger than 5 is high and applying Truncated Rice code with cRiceParam equal to 2 might reduce the number of bits. If the current symbol is 11 and the cRiceParam is 2, the chance that the next symbol is larger than 11 is high and applying Truncated Rice code with cRiceParam equal to 3 might reduce the number of bits.

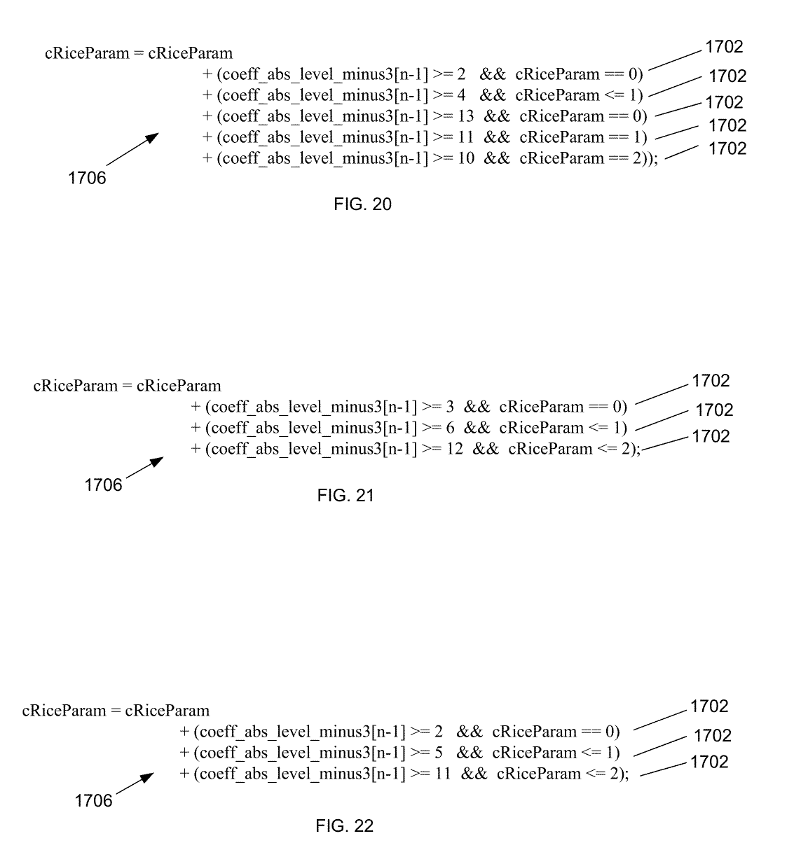

In some embodiments, updating the parameter variable 230 at 1608, referring back to FIG. 16, can be determined from a comparison equation rather than a table. In the comparison, it is determined whether both the last value of the parameter variable 230 and the value of the last coded symbol 226 meet one or more conditions 1702, as illustrated in FIG. 20. In some embodiments, the value of the last coded symbol 226 can be denoted as “coeff_abs_level_minus3[n−1]” as it was in Tables 3-5. The parameter variable 230 can be updated depending on which conditions 1702 are met, and the value of the current symbol 226 can then be coded based on the updated parameter variable 230 using Truncated Rice code and/or Exp-Golomb Code.

In some embodiments, each condition 1702 can comprise two parts, a conditional symbol threshold and a conditional parameter threshold. In these embodiments, the condition 1702 can be met if the value of the symbol 226 is equal to greater than the conditional symbol threshold and the parameter variable 230 is equal to or greater than the conditional parameter threshold. In alternate embodiments, each condition 1702 can have any number of parts or have any type of condition for either or both the symbol 226 and parameter variable 230.

Since updating tables can need extra memory to store and fetch the data and the memory can require a lot of processor cycles, it can be preferable to use combination logics to perform the comparison in place of an updating table as the logic can use very few processor cycles. An example of the combination logic that determines the cRiceParam for updating in the place of Table 3 is shown in FIG. 20. An example of combination logic for representing Table 4 is shown in FIG. 21. An example of combination logic for representing Table 5 is shown in FIG. 22.

In some embodiments, the possible outcomes of the conditions 1702 based on possible values of the parameter variable 230 and the last coded symbols 226 can be stored in memory as a low complexity update table 1704 as illustrated in the table of FIG. 17 as well as other subsequent figures. In these embodiments, the parameter variable 230 can be updated by performing a table lookup from the low complexity update table 1704 based on the last value of the parameter variable 230 and the value of the last coded symbol 226.

In further embodiments, a low complexity level parameter updating table in CABAC can be provided that in some embodiments can operate more efficiently than previous tables and not require the logic illustrated in FIGS. 20-22. For these low complexity level parameter updating tables, the following applies: (1) Inputs: Previous cRiceParam and coeff_abs_level_minus3[n−1]. (2) Outputs: cRiceParam. (3) Previous cRiceParam and cRiceParam could have a value of 0, 1, 2 or 3.

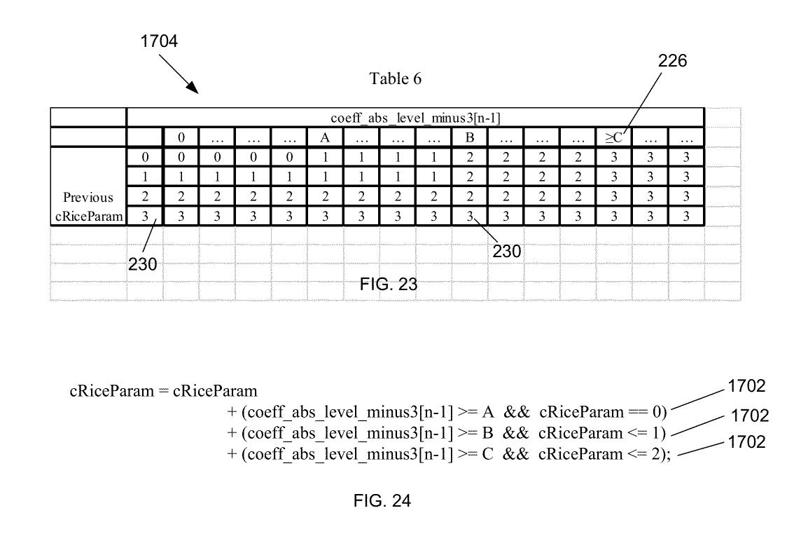

Further in this low complexity level parameter updating tables, the following further applies: (1) The parameter variable 230 can: remain the same when the value of the last coded symbol 226 is between 0 and A−1; (2) The parameter variable 230 can be set to one or remain at the last value of the parameter variable 230, whichever is greater, when the symbol 226 is between A and B−1; (3) The parameter variable 230 can be set to two or remain at the last value of the parameter variable 230, whichever is greater, when the symbol 226 is between B and C−1; or (4) The parameter variable 230 can be set to three when the symbol 226 is greater than C−1. The low complexity update table 1704, labeled Table 6, for these conditions 1702 is depicted in FIG. 23. The combination logic representation for Table 6 is depicted in FIG. 24. The values of A, B, and C can be set to any desired values. In this exemplary embodiment, A, B, or C can be the conditional symbol threshold respectively, and the value of 0, 1, or 2 can be the parameter symbol threshold respectively.

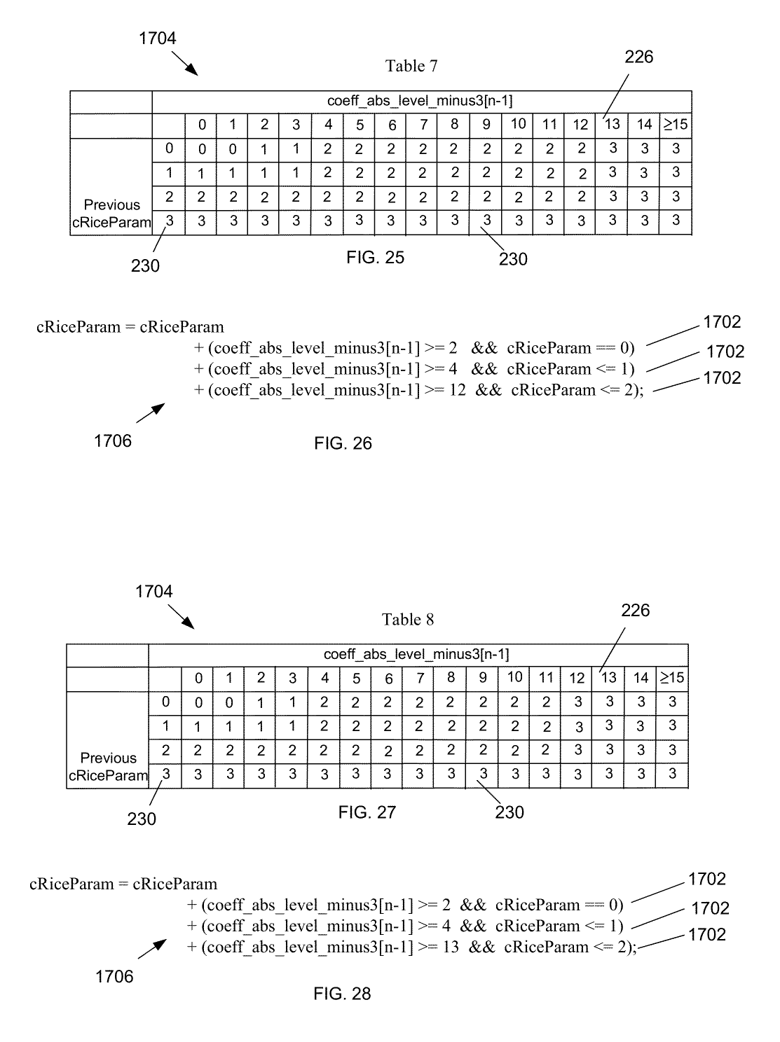

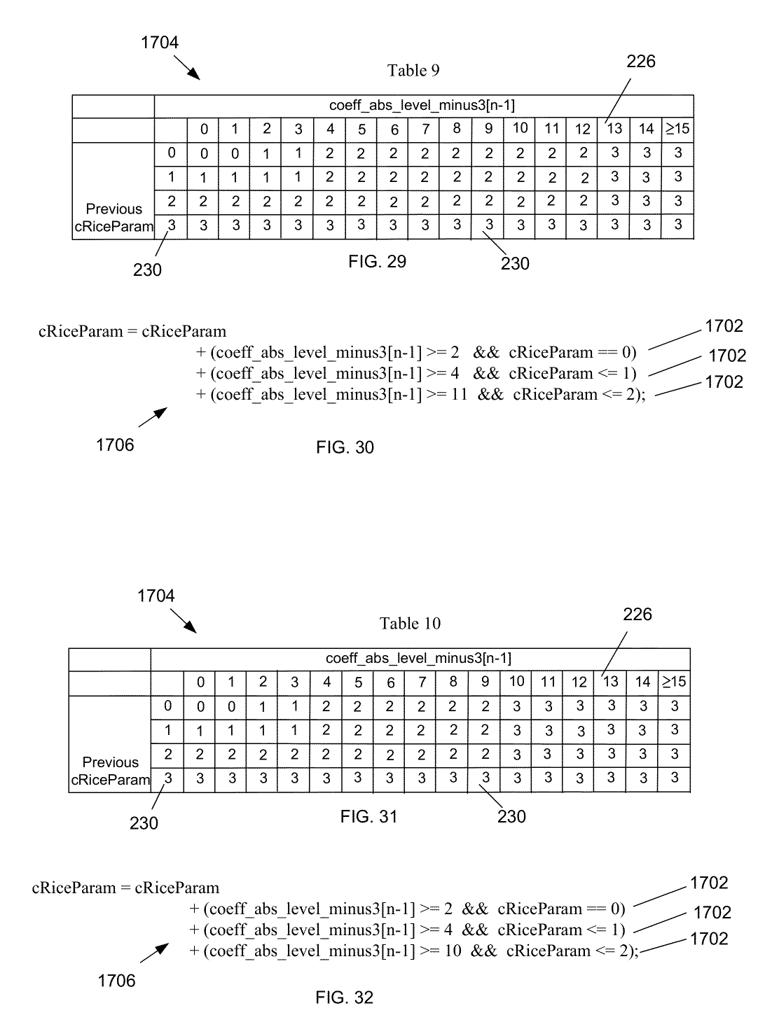

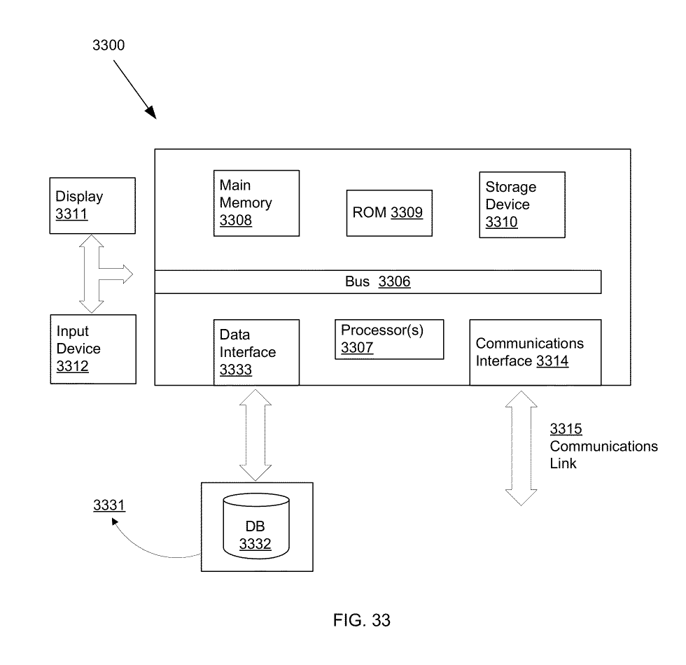

A selection of non-limiting examples of update tables 1704 and their associated combination logic representations 1706 with particular values of A, B, and C, are depicted in FIGS. 19-31. FIGS. 19 and 20 respectively depict an update table 1704 and combination logic representation for conditional symbol thresholds of 3, 6, and 13. FIGS. 29 and 30 respectively depict an update table 9 and combination logic representation for conditional symbol thresholds of 2, 4, and 11. FIGS. 31 and 32 respectively depict an update table 10 and combination logic representation for conditional symbol thresholds of 2, 4, and 10.

The execution of the sequences of instructions required to practice the embodiments may be performed by a computer system 3300 as shown in FIG. 20. In an embodiment, execution of the sequences of instructions is performed by a single computer system 3300. According to other embodiments, two or more computer systems 3300 coupled by a communication link 3315 may perform the sequence of instructions in coordination with one another. Although a description of only one computer system 3300 may be presented herein, it should be understood that any number of computer systems 3300 may be employed.

A computer system 3300 according to an embodiment will now be described with reference to FIG. 20, which is a block diagram of the functional components of a computer system 3300. As used herein, the term computer system 3300 is broadly used to describe any computing device that can store and independently run one or more programs.

The computer system 3300 may include a communication interface 3314 coupled to the bus 3306. The communication interface 3314 provides two-way communication between computer systems 3300. The communication interface 3314 of a respective computer system 3300 transmits and receives electrical, electromagnetic or optical signals that include data streams representing various types of signal information, e.g., instructions, messages and data. A communication link 3315 links one computer system 3300 with another computer system 3300. For example, the communication link 3315 may be a LAN, an integrated services digital network (ISDN) card, a modem, or the Internet.

A computer system 3300 may transmit and receive messages, data, and instructions, including programs, i.e., application, code, through its respective communication link 3315 and communication interface 3314. Received program code may be executed by the respective processor(s) 3307 as it is received, and/or stored in the storage device 3310, or other associated non-volatile media, for later execution.

In an embodiment, the computer system 3300 operates in conjunction with a data storage system 3331, e.g., a data storage system 3331 that contains a database 3332 that is readily accessible by the computer system 3300. The computer system 3300 communicates with the data storage system 3331 through a data interface 3333.

Computer system 3300 can include a bus 3306 or other communication mechanism for communicating the instructions, messages and data, collectively, information, and one or more processors 3307 coupled with the bus 3306 for processing information. Computer system 3300 also includes a main memory 3308, such as a random access memory (RAM) or other dynamic storage device, coupled to the bus 3306 for storing dynamic data and instructions to be executed by the processor(s) 3307. The computer system 3300 may further include a read only memory (ROM) 3309 or other static storage device coupled to the bus 3306 for storing static data and instructions for the processor(s) 3307. A storage device 3310, such as a magnetic disk or optical disk, may also be provided and coupled to the bus 3306 for storing data and instructions for the processor(s) 3307.

A computer system 3300 may be coupled via the bus 3306 to a display device 3311, such as an LCD screen. An input device 3312, e.g., alphanumeric and other keys, is coupled to the bus 3306 for communicating information and command selections to the processor(s) 3307.

According to one embodiment, an individual computer system 3300 performs specific operations by their respective processor(s) 3307 executing one or more sequences of one or more instructions contained in the main memory 3308. Such instructions may be read into the main memory 3308 from another computer-usable medium, such as the ROM 3309 or the storage device 3310. Execution of the sequences of instructions contained in the main memory 3308 causes the processor(s) 3307 to perform the processes described herein. In alternative embodiments, hard-wired circuitry may be used in place of or in combination with software instructions. Thus, embodiments are not limited to any specific combination of hardware circuitry and/or software.

Although the present invention has been described above with particularity, this was merely to teach one of ordinary skill in the art how to make and use the invention. Many additional modifications will fall within the scope of the invention, as that scope is defined by the following claims.

What is claimed is:

1. A method of determining binary codewords for transform coefficients, comprising:
providing a transform unit comprising one or more subsets of the transform coefficients, each of the transform coefficients having a quantized value;
determining a symbol for each of the transform coefficients that have a quantized value equal to or greater than a threshold value, by subtracting said threshold value from the quantized value of said transform coefficient;
providing a parameter variable set to an initial value of zero;
converting the symbols into a binary codeword based on a current value of said parameter variable and a value of said symbol; and
updating the value of said parameter variable with a new current value for each of the symbols after each symbols has been converted, said new current value being based at least in part on the last value of said parameter variable and the value of the last converted symbol.

2. The method of claim 1, wherein said converting comprises looking up said binary codeword from a table based on the value of the said symbol and said updated value of said parameter variable.

3. The method of claim 1, wherein said threshold value is three.

4. The method of claim 1, wherein updating said parameter variable comprises: looking up said new value from a table based on: (1) the last value of said parameter variable, and (2) the value of the last converted symbol.

5. The method of claim 1, wherein updating said parameter variable comprises:
determining whether the last value of said parameter variable and the value of the last converted symbol together satisfy one or more conditions.

6. The method of claim 5, wherein each of said one or more conditions comprises a conditional symbol threshold and a conditional parameter threshold.

7. The method of claim 5, wherein one of said one or more conditions is satisfied when the value of the last converted symbol is greater than or equal to said conditional symbol threshold for that condition and the last value of said parameter variable is less than or equal to said conditional parameter threshold for that condition.

8. The method of claim 7, wherein said conditional symbol threshold is different for each of said one or more conditions.

9. The method of claim 1, wherein the value of said parameter variable is configured to be zero, one, two, or three.

10. The method of claim 1, wherein the value of said parameter variable is configured to be zero, one, two, or any integer between two and a designated upper limit value.

11. The method of claim 1, wherein the transform coefficients are provided within a transform unit (TU) that provides a subdivision of a coding unit (CU) in a High Efficiency Video Coding (HEVC) signal.

12. The method of claim 1, wherein the transform coefficients are provided within a subset of a transform unit (TU) that provides a subdivision of a coding unit (CU) in a High Efficiency Video Coding (HEVC) signal.

13. A method of determining binary codewords for transform coefficients, comprising:
providing a transform unit comprising one or more subsets of the transform coefficients, of the each transform coefficients having a quantized value;
determining a symbol for each of the transform coefficients that have a quantized value equal to or greater than a threshold value, by subtracting said threshold value from the quantized value of said transform coefficient;
providing a parameter variable set to an initial value of zero;
converting the symbols into a binary codeword based on a current value of said parameter variable and a value of said symbol;
looking up a new current value from a table based on the last value of said parameter variable and the value of the last converted symbol; and
replacing the value of said parameter variable with said new current value.

14. A method of determining binary codewords for transform coefficients, comprising:
providing a transform unit comprising one or more subsets of transform coefficients, each transform coefficient having a quantized value;
determining a symbol for each transform coefficient having a quantized value equal to or greater than a threshold value, by subtracting said threshold value from the quantized value of said transform coefficient;
providing a parameter variable set to an initial value of zero;
converting each symbol into a binary codeword based on the current value of said parameter variable and the value of said symbol; and
determining whether the last value of said parameter variable and the value of the last converted symbol together satisfy one or more conditions; and
mathematically adding an integer of one to the last value of said parameter variable for each of said one or more conditions that are satisfied.

15. The method of claim 14, wherein each of said one or more conditions comprises a conditional symbol threshold and a conditional parameter threshold.

16. The method of claim 14, wherein one of said one or more conditions is satisfied when the value of the last converted symbol is greater than or equal to said conditional symbol threshold for that condition and the last value of said parameter variable is less than or equal to said conditional parameter threshold for that condition.

17. The method of claim 16, wherein said conditional symbol threshold is different for each of said one or more conditions.

18. The method of claim 14, wherein the value of said parameter variable is configured to be zero, one, two, or three.

19. The method of claim 14, wherein the value of said parameter variable is configured to be zero, one, two, or any integer between two and a designated upper limit value.
